(19) United States
(12) Patent Application Publication
(10) Pub. No.: US 2015/0251848 A1
(43) Pub. Date: Sep. 10, 2015

(54) LEAF BAGGING EQUIPMENT AND METHOD

(71) Applicant: Stephen Sanders, Reston, VA (US)

(72) Inventor: Stephen Sanders, Reston, VA (US)

(21) Appl. No.: 14/198,412

(22) Filed: Mar. 5, 2014

(51) Int. Cl. B65F 1/00

(52) U.S. Cl. CPC B65F 1/002; B65F 1/0006; B65F 2240/138

(57) ABSTRACT

A leaf or lawn debris collecting and bagging assembly is made up of a rectangular flexible sheet (including a square configuration) configured with two handles as part of the sheet, which are connected to the four corners of the sheet and are used for the fast and easy conversion of the sheet into a bag thereby enclosing the leaves or lawn debris placed on the sheet in the converted bag.

### CROSS-REFERENCE TO RELATED APPLICATIONS

The present invention relates to Provisional Application “Leaf bagging equipment and method” 61/853356.

### BACKGROUND OF THE INVENTION

The use of plastic bags for yard work such as leaf collection is especially difficult without the use of either another individual or some sort of rigid mechanism to hold the bag. One type of rigid mechanism is a trash container that houses the plastic bag. The use of the trash container often creates the problem of not being able to extract the bag from the container because the compressed leaves in the bag are pushing against the inside wall of the container. Another type of rigid mechanism to hold the plastic bag is a metal frame. The problem with this is that often the bag tears when being used. A solution to these problems is to use a flat sheet and place the leaves onto this sheet and then use the sheet handles to quickly and easily transform the sheet into a bag to contain the leaves.

### SUMMARY OF THE INVENTION

The invention describes the configuration and method of use of rectangular plastic sheets adapted to be formed into bags for the bagging of leaves and other lawn debris. Such sheets have two handles as part of the sheet, which are connected to the four corners of the sheet and are used for the fast and easy conversion of the sheet into a bag. Leaves, which are raked onto the sheet are quickly and easily bagged into the converted bag.

### BRIEF DESCRIPTION OF THE DRAWINGS

FIG. 1 is a top view of the flexible rectangular (including a square configuration) sheet labeling the four corners of the flexible sheet as “A”, “B”, “C”, and “D”. Also shown are the two strips, which make up the handles, are part of the flexible sheet and are labeled “L” for left side, and “R” for right side and are created by the incisions “I1” and “I2” respectively. As can be seen on the drawing, strip “L” is connected to corners “A” and “B”, and strip “R” is connected to corners “C” and “D” and provide for the combined joining of corners “A”, “B”, “C”, and “D”, thereby effectively converting the sheet into a bag to contain the leaves.

FIG. 2 is a three dimension view of the sleeve used to hold or “lock” the handles in place as they are drawn through the sleeve, thereby enclosing the tightly packed leaves in the converted bag. The drawing shows the “L” and “R” handle strips passed through the sleeve with the four corners “A”, “B”, “C”, and “D” of the sheet to follow.

### DETAILED DESCRIPTION OF THE INVENTION

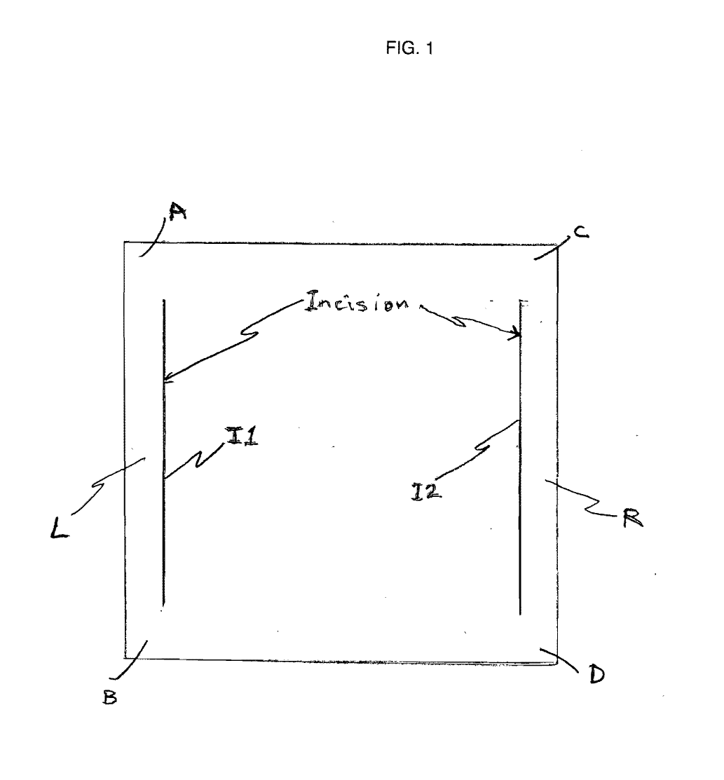

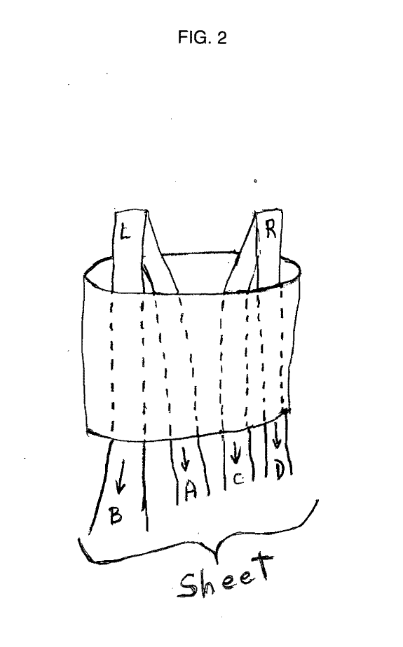

The invention relates to flexible bags containing leaves, grass clippings, loose trash, refuse, assorted materials etc., hereinafter referred to as leaves, and more particularly to a flexible sheet which when spread out on the ground provides a collecting surface on which the leaves are to be gathered or placed and having two flexible strips (“L” and “R”), created by an incision through the sheet (“I1” and “I2”) on opposite sides (left and right) of the sheet which are part of the flexible sheet and are each connected to the two adjacent corners (“A” and “B”, and “C” and “D”) of the flexible sheet (see FIG. 1), and which provide for the easy and convenient method of joining the four corners of the flexible sheet by tightly tying the two flexible strips together such that the contents of leaves are tightly packed, and such that the sheet converts, in shape, to a bag to contain the tightly packed leaves and store them for disposal with the bag. The incisions can be color marked for ease of visual locating. Alternatively, instead of tying the two flexible strips together, they can be passed through a sleeve (see FIG. 2) which will “sandwich” or squeeze the two flexible strips and connected sheet and will by this created pressure effectively tie or join together the strips and the connected four corners of the sheet and aid in the leaves in the bag being tightly packed.

The material of the flexible sheet can be of any material that is flexible and sheet configurable, e.g., plastic, cloth, Kevlar, paper, etc. and can be of any color or clear. The shape of the flexible sheet can be rectangular, including a square configuration. The dimensions of the sheet will vary for the specific application being applied. The material of the sleeve can be of any solid material that will allow for the two flexible strips and connected four corners of the flexible sheet to be squeezed tightly, thereby containing the leaves. The dimensions of the sleeve also will vary for the specific application being applied and the sheet material being used. Additionally, the sleeve may be configurable such that it comprises a “locking” or “holding” feature to keep the sleeve in place with the leaves in the bag being tightly packed, e.g., shape of sleeve, notch in sleeve, etc.

Method of Operation is as follows: Spread out the flexible plastic sheet flat on the surface of the ground. The leaves to be disposed are then gathered and place onto the center portion area of the flexible sheet until they are piled high, so as to contain the pile of leaves. Strips “L” and “R” are grasped at approximately their length mid-point and brought and tied together tightly thereby effectively joining the four corners of the flexible sheet and effectively converting the sheet to a bag which contains the leaves to be disposed. Alternatively, instead of tying the two flexible strips together, they can be passed through the sleeve (see FIG. 2) or through the tunnel of a partially open fist and effectively tie or join together the strips and the connected four corners of the sheet and aid in the leaves in the bag being tightly packed.

1. A single flat-lying flexible rectangular sheet (including a square configuration) with two handle strips, hereafter referred to as handles, located opposite and parallel to each other and located at the edge of the sheet, and used for the fast and easy converting of the sheet into a bag.

2. The sheet according to claim 1 converting into a bag.

3. The sheet according to claim 1 wherein said sheet comprised of plastic or polyethylene or polypropylene or cloth, or Kevlar, or paper, or any flexible material.

4. The sheet according to claim 1 wherein said sheet can be any color, or be clear.

5. A sleeve used to join the handles and subsequently the four corners of the sheet for the converting of the sheet into a bag.

6. The sleeve according to claim 5 comprised of any solid material that will allow for the two flexible strips and connected four corners of the flexible sheet to be squeezed tightly, thereby containing the leaves.

7. The sleeve according to claim 6 comprised of a “locking” or “holding” feature to keep the sleeve in place with the leaves in the bag being tightly packed.
